(19) United States
(12) Patent Application Publication
(10) Pub. No.: US 2022/0029483 A1
(43) Pub. Date: Jan. 27, 2022

(54) Embedded Magnet Arrangement for Permanently Excited Electrical Machines

(71) Applicant: Bayerische Motoren Werke Aktiengesellschaft, Muenchen (DE)

(72) Inventor: Norman BORCHARDT, Oberschleissheim (DE)

(21) Appl. No.: 17/311,558

(22) PCT Filed: Jan. 15, 2020
(86) PCT No.: PCT/EP2020/050873

§ 371 Date: Jun. 7, 2021

(30) Foreign Application Priority Data
Feb. 1, 2019 (DE) 10 2019 102 540.0

(51) Int. Cl. H02K 1/27; H02K 21/14

(52) U.S. Cl. CPC H02K 1/2773; B60K 6/26; H02K 21/14

(57) ABSTRACT

A moving part for a permanently excited electrical machine includes a laminated core and an embedded permanent-magnet system, which has, for each magnetic pole, a first permanent-magnet configuration and a second permanent-magnet configuration for jointly generating a magnetic air-gap flux density in an air gap of the electrical machine, which air gap adjoins an outer side of the laminated core, by superimposition of magnetic fluxes of the two permanent-magnet configurations. The two permanent-magnet configurations have, for each magnetic pole, different arrangements and magnetization orientations with respect to a movement axis of the moving part, and a magnetic flux which results from an arrangement and magnetization orientation of the second permanent-magnet configuration is configured to act on a magnetic flux which results from an arrangement and magnetization orientation of the first permanent-magnet configuration to reduce its magnetic stray flux component.

### BACKGROUND AND SUMMARY OF THE INVENTION

The invention relates to a moving part for a permanently excited electrical machine, the moving part having at least two magnetic poles, and the moving part comprising a laminated core and a permanent-magnet system which is embedded in the laminated core. The invention also relates to a permanently excited electrical machine and also to a motor vehicle.

The focus of interest in the present case is on permanently excited electrical machines which have a part which is mounted in a stationary manner and has windings to which current can be applied and also have a part which is mounted such that it can move with respect to the part which is mounted in a stationary manner. The electrical machine can be a rotationally operating electrical machine comprising a stationary part in the form of a stator and a moving part in the form of a rotor, which electrical machine can be used, for example, as a drive machine for an electrically driveable motor vehicle, that is to say an electric or hybrid vehicle. However, the electrical machine can also be a translationally operating electrical machine comprising a stationary part in the form of a stationary component and a moving part in the form of a rotating component, for example a linear motor. The rotor or rotating component has a permanent-magnet system which can have, for example, surface magnets or embedded or buried permanent magnets.

Magnetic leakage fluxes are produced in such permanently excited electrical machines with embedded permanent-magnet systems. These magnetic leakage fluxes reduce a magnetic air-gap flux density, which can be used for the electromechanical conversion, in an air gap between the stationary part and the moving part. As a result, a maximum torque that can be converted in rotationally operating electrical machines or a maximum force that can be converted in translationally operating electrical machines is reduced. That is to say, the lower the magnetic leakage fluxes, the more effectively the electrical machine can be operated.

The object of the present invention is to provide a permanently excited electrical machine which can be operated in a particularly effective and efficient manner and has a very high yield of a magnetic air-gap flux density.

This object is achieved by the claimed invention.

A moving part according to embodiments of the invention for a permanently excited electrical machine has at least two magnetic poles and comprises a laminated core and a permanent-magnet system which is embedded in the laminated core. The permanent-magnet system has, for each magnetic pole, a first permanent-magnet configuration and a second permanent-magnet configuration. The first permanent-magnet configuration and the second permanent-magnet configuration are designed for jointly generating a magnetic air-gap flux density in an air gap of the electrical machine, which air gap radially adjoins an outer side of the laminated core, by superimposition of magnetic fluxes of the two permanent-magnet configurations. The two permanent-magnet configurations have, for each magnetic pole, different arrangements and magnetization orientations with respect to a movement axis of the moving part. In this case, a magnetic flux of the second permanent-magnet configuration, which magnetic flux results from an arrangement and magnetization orientation of the second permanent-magnet configuration, is additionally designed to act on a magnetic flux of the first permanent-magnet configuration, which magnetic flux results from an arrangement and magnetization orientation of the first permanent-magnet configuration, and in so doing at least to reduce a magnetic leakage flux component of the magnetic flux of the first permanent-magnet configuration.

The invention also relates to a permanently excited electrical machine having a stationary part and a moving part according to the invention which is mounted such that it can move in relation to the stationary part so as to form an air gap. The stationary part has a laminated core with windings to which current can be applied. The electrical machine can be a rotationally operating or rotating electrical machine comprising a stationary part in the form of a stator and a moving part in the form of a rotor or can be a translationally operating electrical machine comprising a stationary part in the form of a stationary component and a moving part in the form of a rotating component, for example a linear motor. In the text which follows, the expression “rotor/rotating component” is used for the term “moving part” if the term is intended to mean both the rotor and the rotating component and the expression “stator/stationary component” is used for the term “stationary part” if the term is intended to mean both the stator and the stationary component. In rotationally operating machines, the rotor and the stator are situated opposite one another in the radial direction proceeding from a movement axis which is designed as a rotation axis and around which the rotor rotates. In translationally operating machines, the rotating component and the stator are situated opposite one another in the vertical direction proceeding from a movement axis which is designed as a thrust axis and along which the rotating component moves.

The laminated core of the rotor/rotating component has at least two alternating magnetic poles, wherein a region of the laminated core is assigned to each magnetic pole. Two adjacent, alternating magnetic poles in the form of a magnetic south pole and a magnetic north pole form a pole pair. In this case, each magnetic pole of the laminated core has the first and the second permanent-magnet configuration, wherein the first and the second permanent-magnet configurations of all the magnetic poles form the permanent-magnet system of the rotor. Each of the permanent-magnet configurations has at least one permanent magnet which is designed as an embedded or buried permanent magnet. For this purpose, hollow spaces are formed in the laminated core, which hollow spaces extend through the laminated core and in which hollow spaces the permanent magnets are arranged.

On account of the permanent-magnet configurations which are designed as magnetic sources being embedded in the laminated core, the magnetic fluxes of the permanent-magnet configurations pass through the laminated core and also the air gap and return again to the magnetic source via the stator/stationary component. As they pass through the laminated core of the rotor/rotating component, the magnetic fluxes of the two permanent-magnet configurations are superimposed on or overlap each other and thereby jointly generate the magnetic air-gap flux density. Therefore, both permanent-magnet configurations make a contribution to the magnetic air-gap flux density. In this case, the first permanent-magnet configuration has a first arrangement and a first magnetization orientation with respect to the movement axis and the second permanent-magnet configuration has a second arrangement and a second magnetization orientation with respect to the movement axis. As a result, the two permanent-magnet configurations also have, for each magnetic pole, different arrangements and magnetization orientations from one another. For the purpose of forming the alternating magnetic poles, the respective magnetization orientations within one pole pair change their sign. In other words, the first magnetization orientations of two adjacent magnetic poles which form a pole pair have different signs and the second magnetization orientations of the adjacent magnetic poles have different signs.

For example, first permanent magnets of the first permanent-magnet configuration and second permanent magnets of the second permanent-magnet configuration can have different positions in relation to one another and with reference to the movement axis for the purpose of forming the different arrangements. The position of a permanent magnet with respect to the movement axis is defined as a position of a magnet longitudinal axis with respect to the movement axis here. A first position of the first permanent magnet and a second position of the second permanent magnet can be oriented transversely, for example perpendicularly, in relation to one another. The different positions of the permanent magnet with respect to the movement axis result in the different magnetization orientations. The magnetization orientation is defined as the position of a magnetization direction of a permanent magnet in relation to the movement axis here. The magnetization direction and the magnet longitudinal axis of a permanent magnet are oriented perpendicularly in relation to one another here. The first and the second magnetization orientation can likewise be oriented transversely, for example perpendicularly, in relation to one another.

In this case, the second permanent-magnet configuration is arranged and magnetized in relation to the first permanent-magnet configuration and in relation to the movement axis in such a way that it contributes not only to the magnetic air-gap flux density but also reduces the magnetic leakage flux component of the first permanent-magnet configuration. For example, as it passes through the laminated core, a second magnetic flux of the second permanent-magnet configuration can deflect or even compensate for the magnetic leakage flux of the first permanent-magnet configuration. Owing to the superimposition of the magnetic fluxes of the two permanent-magnet configurations, the permanent magnets of the permanent-magnet configurations can be designed with the same expenditure on material as permanent magnets of a rotor with only one permanent-magnet configuration. Therefore, the expenditure on material for the electrical machine is advantageously not increased by the second permanent-magnet configuration. Instead, the magnetic leakage fluxes are reduced by the second permanent-magnet configuration and as a result magnetic flux in the laminated core is improved. Therefore, a torque or a force of the electrical machine can be increased.

It proves to be advantageous if the arrangement of the first permanent-magnet configuration is designed as an embedded flat magnet arrangement and the arrangement of the second permanent-magnet configuration is designed as an embedded spoke arrangement. In the flat magnet arrangement, the magnet longitudinal axis of the first permanent magnet is oriented, in particular, tangentially or parallel in relation to the air gap and therefore to the outer side of the laminated core. The first magnetization orientation is oriented at a specific angle, in particular perpendicularly, in relation to the outer side of the laminated core. In such a flat magnet arrangement, the magnetic air-gap flux density corresponds approximately to the magnetic flux density of the flat magnet arrangement minus the magnetic leakage fluxes.

In the spoke arrangement, two second permanent magnets are situated opposite one another for each magnetic pole, wherein the positions or magnet longitudinal axes of the second permanent magnets are oriented at a specific angle, for example perpendicularly, in relation to the outer side. The magnetization directions of the second permanent magnets have the same position with respect to the outer side and in relation to the movement axis, but face one another, so that the magnetic fluxes of the permanent magnets are concentrated along a flux concentration direction as they pass through the laminated core. In a permanent-magnet system comprising flat magnet arrangements and spoke arrangements, the magnetic fluxes of the arrangements overlap and therefore jointly contribute to the magnetic air-gap flux density. The arrangements therefore advantageously result in a very high yield of the magnetic air-gap flux density. The magnetic leakage fluxes in the laminated core form, in particular, at the ends of the first permanent magnets, which ends are situated close to the air gap in the flat magnet arrangement. The magnetic flux of the spoke arrangement, which magnetic flux is, in particular, stronger than the magnetic leakage flux of the flat magnet arrangement and is directed opposite to the magnetic leakage flux, therefore reduces the magnetic leakage flux component of the flat magnet arrangement.

According to the embodiment of the rotationally operating electrical machine, the first permanent-magnet configuration in the flat magnet arrangement has a radial magnetization orientation with respect to the rotation axis and the second permanent-magnet configuration in the spoke arrangement has a tangential magnetization orientation with respect to the rotation axis. With reference to the rotation axis, the first magnetization direction of the first permanent magnets of the first permanent-magnet configuration is therefore a radial direction. The magnet longitudinal axis of the first permanent magnets is oriented in the tangential direction with reference to the rotation axis. In other words, the first permanent magnets are in a tangential position in relation to the rotation axis. With reference to the rotation axis, the second magnetization direction of the second permanent magnets of the second permanent-magnet configuration is the tangential direction. The magnet longitudinal axis of the second permanent magnets is oriented in the radial direction with reference to the rotation axis. In other words, the second permanent magnets are in a radial position in relation to the rotation axis.

According to the embodiment of the translationally operating electrical machine, the first permanent-magnet configuration in the flat magnet arrangement has a vertical magnetization orientation with respect to a movement axis which is designed as a thrust axis and the second permanent-magnet configuration in the spoke arrangement has a horizontal magnetization orientation with respect to the thrust axis. With reference to the thrust axis, the first magnetization direction of the first permanent magnets of the first permanent-magnet configuration is a vertical direction or transverse direction. The magnet longitudinal axis of the first permanent magnets is oriented in the horizontal direction or longitudinal direction with reference to the thrust axis. In other words, the first permanent magnets are in a horizontal position in relation to the thrust axis. With reference to the thrust axis, the second magnetization direction of the second permanent magnets of the second permanent-magnet configuration is the horizontal direction. The magnet longitudinal axis of the second permanent magnets is oriented in the horizontal direction with reference to the thrust axis. In other words, the second permanent magnets are in a vertical position in relation to the thrust axis.

The first permanent-magnet configuration preferably has, for each magnetic pole, a first permanent magnet which is divided into two permanent-magnet parts, wherein the permanent-magnet parts, for the purpose of forming the flat magnet arrangement, are arranged in a V arrangement and are arranged between two second permanent magnets of the second permanent-magnet configuration, which second permanent magnets are arranged at a distance from one another. In this case, the V arrangement has, in particular, an angle of at least 90°. The V arrangement preferably has an angle of 180°, so that the permanent-magnet parts lie next to one another in a line. The second permanent magnets are, for each magnetic pole, spaced apart from one another and are arranged adjacent to the respective magnetic pole edges. In this case, first ends of the second permanent magnets face the rotation axis or thrust axis. Second ends of the second permanent magnets, which second ends are situated opposite the first ends, face the air gap. In this case, the first permanent-magnet parts, which are arranged next to one another, are situated between the two second permanent magnets. In particular, the first permanent-magnet parts are situated between the second ends of the permanent magnets.

In an advantageous development of the invention, in each case at least one magnetic flux barrier element in the laminated core is arranged adjoining at least one end of the second permanent magnets for the purpose of reducing magnetic leakage flux components of second permanent magnets of the second permanent-magnet configuration. The at least one magnetic flux barrier element is preferably designed as a cavity and/or a plastic part in the laminated core. In particular, one magnetic flux barrier element is arranged between the second end of the second permanent magnet, which second end faces the air gap, and the outer side of the laminated core and one magnetic flux barrier element is arranged between the first end of the second permanent magnet, which first end faces the movement axis, and the movement axis. This magnetic flux barrier element advantageously prevents the presence of magnetic leakage fluxes of the second permanent magnet.

The invention also relates to a motor vehicle comprising a permanently excited electrical machine according to the invention. The motor vehicle is, in particular, an electric or hybrid vehicle and comprises the electrical machine as a traction machine or drive machine.

The embodiments presented with reference to the rotor according to the invention and the advantages of the embodiments correspondingly apply to the electrical machine according to embodiments of the invention and also to the motor vehicle according to embodiments of the invention.

Further features of the invention emerge from the claims, the FIGURE and the description of the FIGURE. The features and combinations of features cited in the description above and the features and combinations of features cited in the description of the FIGURE below and/or shown in the FIGURE alone can be used not only in the respectively indicated combination but also in other combinations or on their own.

The invention will now be explained in more detail on the basis of a preferred exemplary embodiment and with reference to the drawing.

### BRIEF DESCRIPTION OF THE DRAWING

FIG. 1 shows a schematic sectional illustration of a sector of an embodiment of an electrical machine 1 according to embodiments of the invention.

### DETAILED DESCRIPTION OF THE DRAWING

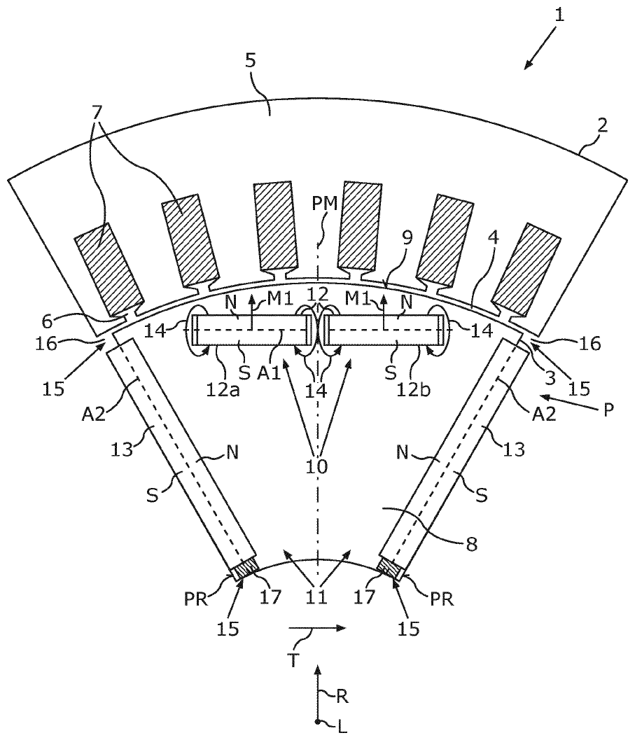

In the present case, as shown in FIG. 1, the electrical machine 1 is designed as a rotationally operating electrical machine and can be designed, for example, as an electrical traction machine of an electrically driveable motor vehicle, not shown here. As an alternative to this, the electrical machine 1 can also be designed as a translationally operating electrical machine. The electrical machine 1 comprises a stationary part in the form of a stator 2 and a moving part in the form of a rotor 3, which moving part is mounted in a rotatable manner about a movement axis in the form of a rotation axis L with respect to the stator 2. Here, the electrical machine 1 is an internal rotating component, so that the stator 2 surrounds the rotor 3 and the rotor 3 rotates about the rotation axis L within the stator 2. As an alternative to this, the electrical machine 1 can also be an external rotating component.

The stator 2 and the rotor 3 are arranged in a manner spaced apart from one another so as to form an air gap 4. The stator 2 has a stator laminated core 5 with a large number of slots 6 which are arranged in a equidistantly distributed manner and in which windings 7 of the stator 2, to which windings current can be applied, are arranged for the purpose of generating a rotating field. The rotor 3 can be excited to rotate about the rotation axis L by this rotating field. The rotor 3 has at least two magnetic poles P, wherein a magnetic pole P in the form of a magnetic north pole is shown here for example. A magnetic pole P, not shown here, in the form of a magnetic south pole follows the magnetic north pole in an adjoining manner. The rotor 3 has a laminated core 8 or rotor laminated core which has an outer side 9 which faces the air gap 4.

In addition, each magnetic pole P has a first permanent-magnet configuration 10 and a second permanent-magnet configuration 11. The first and the second permanent-magnet configurations 10, 11 of all the magnetic poles P form a permanent-magnet system of the rotor 3. In this case, the permanent-magnet configurations 10, 11 are embedded in the laminated core 8 or buried in the laminated core 8. In this case, the first permanent-magnet configuration 10 has a first arrangement and a first magnetization orientation in relation to the rotation axis L. The second permanent-magnet configuration 11 has a second arrangement and a second magnetization orientation in relation to the rotation axis L. Here, the first permanent-magnet configuration 10 has a first arrangement in the form of an embedded flat magnet arrangement, and the second permanent-magnet configuration 11 has a second arrangement in the form of an embedded spoke arrangement.

The first permanent-magnet configuration 10 has a first permanent magnet 12 which is divided into two permanent-magnet parts 12a, 12b. The first permanent magnet 12 is in a tangential position in relation to the rotation axis L for the purpose of forming the first arrangement. For this purpose, a first magnet longitudinal axis A1 of the first permanent magnet 12 is oriented along a tangential direction T with respect to the rotation axis L. The first permanent magnet 12 has a radial magnetization for the purpose of forming the first magnetization orientation. A first magnetization direction M1 of the first permanent magnet 12 is therefore oriented along the radial direction R. In the magnetic pole P in the form of the magnetic north pole shown here, a north pole N of the first permanent magnet 12 faces the air gap 4 and a south pole S of the first permanent magnet 12 faces the rotation axis L. In an adjacent, alternating magnetic pole P in the form of the magnetic south pole, the south pole S of the first permanent magnet 12 would face the air gap 4 and the north pole N of the first permanent magnet 12 would face the rotation axis L. The first magnetization direction M1 therefore changes its sign.

The second permanent-magnet configuration 10 has two second permanent magnets 13. The second permanent magnets 13 are in a radial position in relation to the rotation axis L for the purpose of forming the second arrangement. For this purpose, second magnet longitudinal axes A2 of the second permanent magnets 13 are oriented along a radial direction R with respect to the rotation axis L. The second permanent magnets 13 have a tangential magnetization for the purpose of forming the second magnetization orientation. Second magnetization directions M2 of the second permanent magnets 13 are therefore oriented along the tangential direction T. In the magnetic pole P in the form of the magnetic north pole shown here, north poles N of the second permanent magnets 13 face a pole center PM and south poles S of the second permanent magnets 13 face respective pole edges PR. In an adjacent, alternating magnetic pole P in the form of the magnetic south pole, the south poles S of the second permanent magnets 13 would face the pole center PM and north poles N of the second permanent magnets 12 would face the respective pole edges PR. The second magnetization directions M2 therefore change their signs.

Magnetic fluxes of the two permanent-magnet configurations 10, 11, which magnetic fluxes are initially oriented along the respective magnetization directions M1, M2, overlap or are concentrated along the radial direction R, which corresponds to a magnetic flux concentration direction, and jointly generate a magnetic air-gap flux density in the air gap 4. A profile of the magnetic air-gap flux density influences a torque and an efficiency of the rotationally operating electrical machine 1.

The magnetic flux of the first permanent magnet 12 has a magnetic leakage flux component 14, in particular at ends of the first permanent-magnet parts 12a, 12b, which ends are situated close to the air gap 4. This magnetic leakage flux component 14 has an influence on the profile of the magnetic air-gap flux density and therefore on the efficiency of the electrical machine 1. The magnetic flux of the second permanent magnets 13 acts on the magnetic flux of the first permanent magnet 12 in order at least to reduce this magnetic leakage flux component 14. If, in this case, a magnetic field or a magnetic flux density of the second permanent magnets 13 is stronger than the magnetic leakage flux of the first permanent magnet 12, this first permanent magnet can be entirely or partially deactivated. The stronger magnetic field of the second permanent magnets 13 therefore diverts the magnetic leakage fluxes of the first permanent magnet 12.

Magnetic leakage fluxes can also form at ends of the second permanent magnets 13. In order to prevent these magnetic leakage fluxes of the second permanent magnets 13 from reducing the magnetic air-gap flux density, magnetic flux barrier elements 15 are provided in the laminated core 8. The magnetic flux barrier elements 15 at the ends of the second permanent magnets 13, which ends face the air gap 4, are designed as cavities 16 in the laminated core 8 here. The magnetic flux barrier elements 15 at the ends of the second permanent magnets, which ends are averted from the air gap 4, are designed as plastic parts 17 here.

### LIST OF REFERENCE SYMBOLS

1 Electrical machine
2 Stator
3 Rotor
4 Air gap
5 Stator laminated core
6 Slots
7 Windings
8 Laminated core
9 Outer side
10 First permanent-magnet configuration
11 Second permanent-magnet configuration
12 First permanent magnet
13 Second permanent magnets
14 Magnetic leakage flux
15 Magnetic flux barrier element
16 Cavity
17 Plastic part
R Radial direction
T Tangential direction
L Rotation axis
M1, M2 Magnetization directions
A1, A2 Magnet longitudinal axes
P Magnetic pole
PM Pole center
PR Pole edges
N North pole
S South pole

1.-9. (canceled)

10. A moving part for a permanently excited electrical machine, wherein the moving part has at least two magnetic poles, the moving part comprising:
a laminated core; and
a permanent-magnet system which is embedded in the laminated core, wherein the permanent-magnet system comprises, for each magnetic pole, a first permanent-magnet configuration and a second permanent-magnet configuration for jointly generating a magnetic air-gap flux density in an air gap of the electrical machine, and the air gap adjoins an outer side of the laminated core, by superimposition of magnetic fluxes of the first permanent-magnet configurations and the second permanent-magnet configuration, wherein:
the first permanent-magnet configuration and the second permanent-magnet configuration have, for each magnetic pole, different arrangements and magnetization orientations with respect to a movement axis of the moving part, and
a magnetic flux of the second permanent-magnet configuration is configured to act on a magnetic flux of the first permanent-magnet configuration in order to reduce a magnetic leakage flux component of the magnetic flux of the first permanent-magnet configuration, wherein the magnetic flux of the second permanent-magnet configuration results from an arrangement and magnetization orientation of the second permanent-magnet configuration which magnetic flux of the first permanent-magnet configuration results from an arrangement and magnetization orientation of the first permanent-magnet configuration.

11. The moving part according to claim 10, wherein:
the arrangement of the first permanent-magnet configuration is configured as an embedded flat magnet arrangement, and
the arrangement of the second permanent-magnet configuration is configured as an embedded spoke arrangement.

12. The moving part according to claim 11, wherein:
the moving part is configured as a rotor of a rotationally operating electrical machine,
the first permanent-magnet configuration in the flat magnet arrangement has a radial magnetization orientation with respect to a movement axis which is configured as a rotation axis, and
the second permanent-magnet configuration in the spoke arrangement has a tangential magnetization orientation with respect to the rotation axis.

13. The moving part according to claim 11, wherein:
the moving part is configured as a rotating component of a translationally operating electrical machine,
the first permanent-magnet configuration in the flat magnet arrangement has a vertical magnetization orientation with respect to a movement axis which is configured as a thrust axis, and
the second permanent-magnet configuration in the spoke arrangement has a horizontal magnetization orientation with respect to the thrust axis.

14. The moving part according to claim 11, wherein:
the first permanent-magnet configuration has, for each magnetic pole, a first permanent magnet which is divided into two permanent-magnet parts,
the permanent-magnet parts, to form the flat magnet arrangement, are arranged in a V-shape arrangement and are arranged between two second permanent magnets of the second permanent-magnet configuration, and
second permanent magnets are arranged at a distance from one another to form the spoke arrangement.

15. The moving part according to claim 14, wherein:
at least one magnetic flux barrier element in the laminated core is arranged adjoining ends of the two second permanent magnets to reduce magnetic leakage flux components of the two second permanent magnets.

16. The moving part according to claim 15, wherein:
the at least one magnetic flux barrier element is configured as at least one of a cavity or a plastic part in the laminated core.

17. A permanently excited electrical machine comprising:
a stationary part; and
a moving part which is mounted such that the moving part is movable in relation to the stationary part to form an air gap, wherein the moving part comprises:
a laminated core; and
a permanent-magnet system which is embedded in the laminated core, wherein the permanent-magnet system comprises, for each magnetic pole, a first permanent-magnet configuration and a second permanent-magnet configuration for jointly generating a magnetic air-gap flux density in an air gap of the electrical machine, wherein the air gap adjoins an outer side of the laminated core, by superimposition of magnetic fluxes of the first permanent-magnet configurations and the second permanent-magnet configuration, wherein:
the first permanent-magnet configuration and the second permanent-magnet configuration have, for each magnetic pole, different arrangements and magnetization orientations with respect to a movement axis of the moving part, and
a magnetic flux of the second permanent-magnet configuration is configured to act on a magnetic flux of the first permanent-magnet configuration in order to reduce a magnetic leakage flux component of the magnetic flux of the first permanent-magnet configuration, wherein the magnetic flux of the second permanent-magnet configuration results from an arrangement and magnetization orientation of the second permanent-magnet configuration which magnetic flux of the first permanent-magnet configuration results from an arrangement and magnetization orientation of the first permanent-magnet configuration.

18. A motor vehicle comprising a permanently excited electrical machine according to claim 17.
